(19) United States
(12) Patent Application Publication
(10) Pub. No.: US 2010/0177193 A1
(43) Pub. Date: Jul. 15, 2010

(54) REMOTE AND DIGITAL DATA TRANSMISSION SYSTEMS AND SATELLITE LOCATION FROM MOBILE OR FIXED TERMINALS WITH URBAN SURVEILLANCE CAMERAS FOR FACIAL RECOGNITION, DATA COLLECTION OF PUBLIC SECURITY PERSONNEL AND MISSING OR KIDNAPPED INDIVIDUALS AND CITY ALARMS, STOLEN VEHICLES, APPLICATION OF ELECTRONIC FINES AND COLLECTION THEREOF THROUGH A PERSONAL ID SYSTEM BY MEANS OF A MULTIFUNCTIONAL CARD AND COLLECTION OF SERVICES WHICH ALL OF THE ELEMENTS ARE COMMUNICATED TO A COMMAND CENTER

(75) Inventor: Pedro Castillo Flores, Chihuahua (MX)

Correspondence Address: KRAMER & AMADO, P.C., 1725 DUKE STREET, SUITE 240, ALEXANDRIA, VA, 22314, US

(73) Assignee: Global Sight, S.A. DE C.V., Chihuahua (MX)

(21) Appl. No.: 12/516,325

(22) PCT Filed: Nov. 26, 2007
(86) PCT No.: PCT/MX07/00142

§ 371 Date: Feb. 9, 2010

(30) Foreign Application Priority Data
Nov. 24, 2006 (MX) PA/A/2006013614

(51) Int. Cl. H04N 7/18; G06K 9/00

(52) U.S. Cl. 348/148; 348/159; 382/118; 348/E07.085

(57) ABSTRACT

This invention is related to a remote and digital data transmission system and satellite location from mobile or fixed terminals with urban surveillance cameras for facial recognition, detector of gunshots, data collection of public security personnel and missing or kidnapped individuals, city alarms and vehicles control collecting traffic violations and detection of stolen vehicles, all modules communicated to a command center comprising the combination of a close-up camera placed on a post or structure, camera by means of which a photograph is taken, said photograph is sent to the command center (2) by means of a data link providing the photograph (3), in real time, said photograph is sent to a global module (4) which transmits it to a security filter (5) for its analysis and once the information is confirmed it sends it back to the module (4), and from here it is sent to the individuals identification module (6), and it edits the photograph or card with all data (7) with an arrangement of a series of microphones (8) coupled to a structure and an electronic switchboard (9), said arrangements enable the recognition of sound signatures such as gunshots in different noise intensities, and said command center acts as an information CPU to register the payment of fines by means of automatic traffic violations and different public services addressed to the corresponding individuals by means of a control system of sole identity with capacity in addition for application of payments.

### BACKGROUND OF THE INVENTION

A series of security systems are currently known for recognition of individuals or detection of stolen vehicles and lost individuals or city alarms connected to a database, especially managed by the municipality, state or federal government but each one of these command centers independently function and information takes too long in reaching said command center, therefore, they are not that efficient and as it has been mentioned, these command centers for location and recognition of individuals and vehicles as well as city alarms and independent one from the other and they do not suitable record information to respond exactly at the time a crime or fraud is being committed, hence, most of the times the individuals loose time and their belongings even their lives due to the delay of the corresponding authorities to act; on the other hand, it is not possible to know if the infringer or criminal is a member of the police from the different existing levels or groups because there is no data to evidence the crime/violation in real time.

### PURPOSE OF THE INVENTION

One of the purposes of the invention is to create a system for recognition of individuals in real-time to define if this person has criminal background and therefore, he/she is considered as dangerous.

Other purpose is to incorporate into a single firearms detection system, a series of sounds detection modules to determine when a gunshot is made by detecting the gunshot up to a distance of four hundred meters in the surroundings of an automatic close-up camera.

Another purpose is to create a data recognition system enabling to incorporate a portable city alarm which sends a sound as an alarm to the command center to immediately respond upon pressing it in case of an emergency.

Other purpose of the invention is to create a multiple data network enabling the location of individuals or vehicles in real-time incorporating this information to the emergencies system and to the police vehicles location, in this way, upon detecting an emergency by means of a portable city alarm; it is displayed in the command center.

Another purpose of the invention is the efficient and immediate collection of fines for traffic violations from infringers, thus providing the entity with resources for re-investment in its surveillance equipment and staff. A police officer upon generating a fine has the possibility of verifying by means of a data mobile unit if the vehicle is stolen or if the driving license that the individual has is false, then the fine is generated which is geographically located in the above-stated map and if there is a surveillance camera, the operation is taped and verified by the command center personnel, thus preventing police corruption.

Other purpose of the invention is the recording and following up of vehicles travelling in the streets of the entity by means of automatic location of vehicles through license plates cameras being said cameras connected through a data network to the command center, and said command center may register vehicles with a robbery report on remote control which upon passing in front of a license plates camera are detected and located geographically in the satellite location map.

Another purpose of the invention is the implementation of a multifunctional card system used as an ID card with general data of the individual, such as: address, digital and coded photograph for facial and fingerprint recognition. Likewise, the card will be used as a debit or credit card to make different payments, including public services payments.

The card supplements the police work upon being used as a unique ID of the individual, the police officer has the capacity upon arresting an individual to verify by means of the satellite location system if said individual matches with the recorded data in the sole ID card; likewise, with the characteristics of a credit, debit or prepaid card, the citizen may pay his/her violation at that same place, thus preventing the citizen from corruption acts by providing him/her with more payment formats at that time; likewise, the generation of immediate payment discounts.

Another purpose of the invention is the implementation of a payment system of different services and especially parking services through a system which automatically controls and collects parking payments, thus providing resources for reinvestment in control equipment and staff.

Generated information has two purposes: one is vehicle control by means of vehicle identification units which enable to verify, on remote basis with wireless communication, if a vehicle has been reported as stolen to the command center, verify if it has pending payments for fines or any other type of indebtedness. A police officer has then, the opportunity to verify one-by-one those vehicles with any kind of indebtedness. If that is the case, vehicle arrest is applicable to collect the pending payment or any other type of official action.

This inventions is perfectly applicable to any entity whether municipality, state or federal.

These and other purposes will be evident in the following description and figures identifying with reference numbers their different parts to describe them in the following description.

### BRIEF DESCRIPTION OF FIGURES

FIG. 1 shows a front view of the urban surveillance camera and the command center to which the photograph is sent for facial recognition.

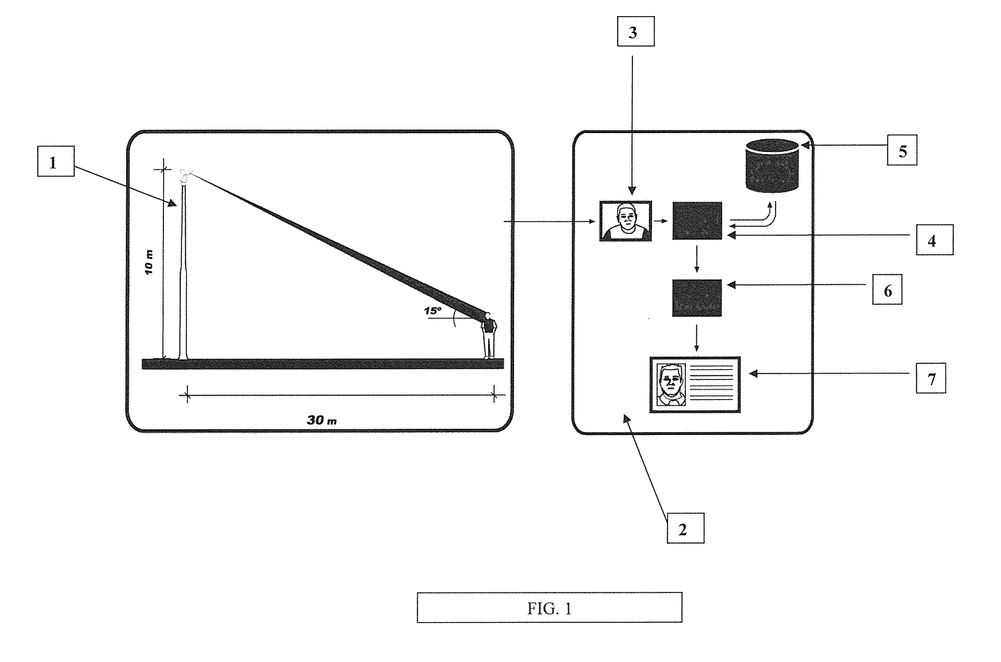

FIG. 2 shows a perspective view of the placement of microphones in an electronic board with its connections to detect gunshots.

FIG. 3 shows a front view of the system for facial recognition of individuals.

FIG. 4 shows a front view of the data collection system of public security personnel.

FIG. 5 shows a front view of the data collection system of innocent people.

FIG. 6 shows a front view of the remote data transmission system from data mobile terminals and satellite location.

FIG. 7 shows the city alarm system.

FIG. 8 shows a front view of the general system for installation of the command center.

FIG. 9 shows a full perspective view of the general system of video-surveillance installation to the command center.

### DETAILED DESCRIPTION OF THE INVENTION

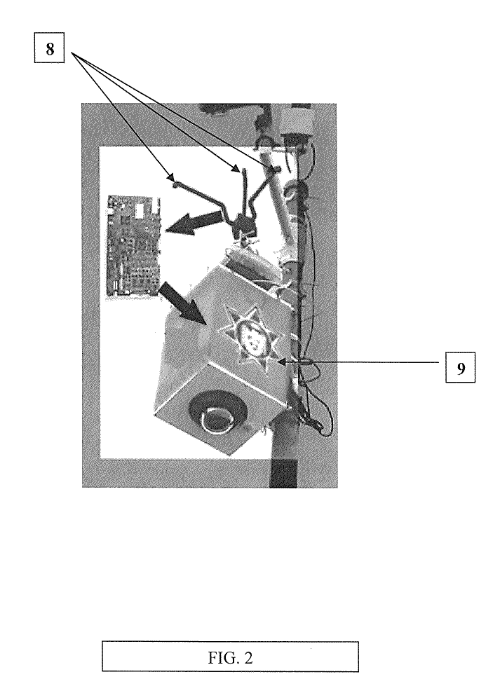

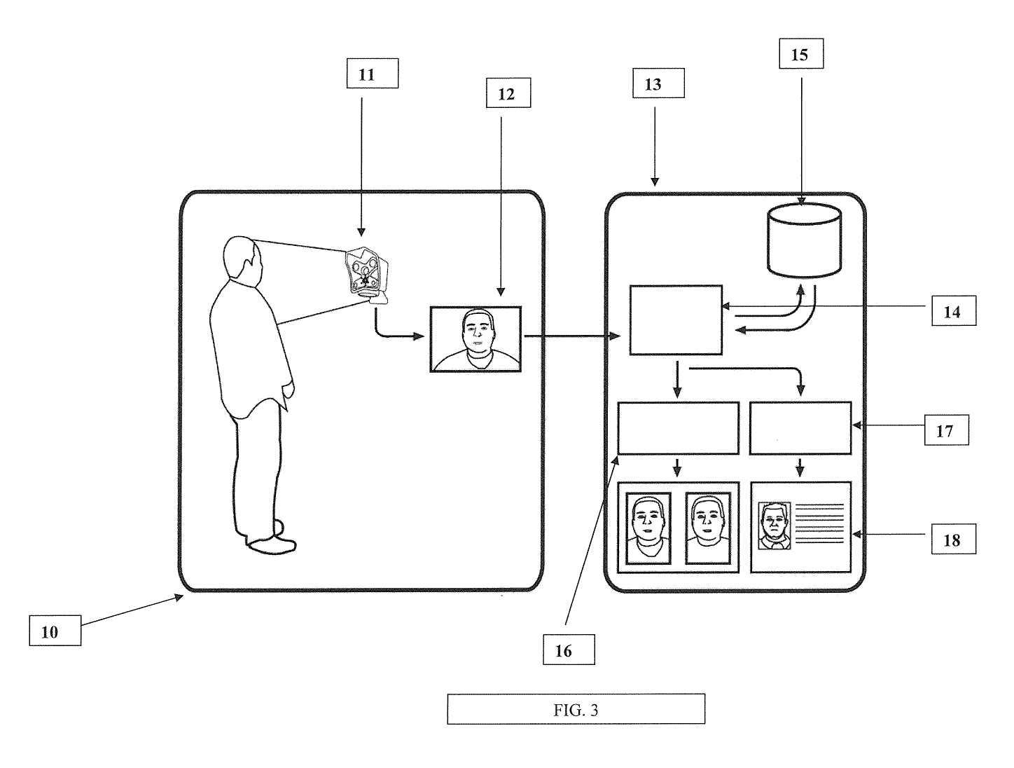

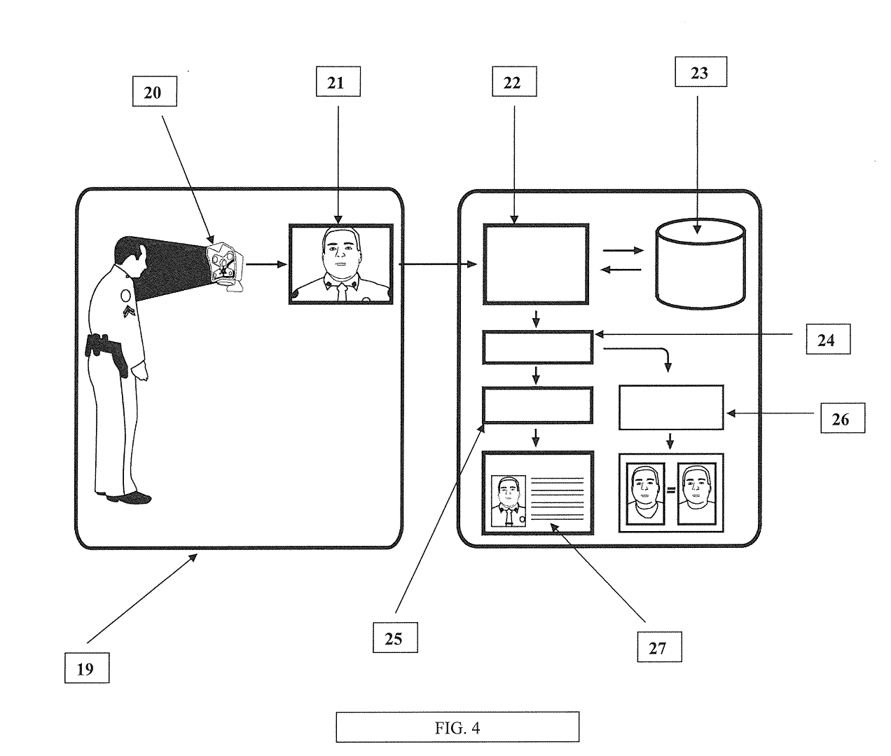

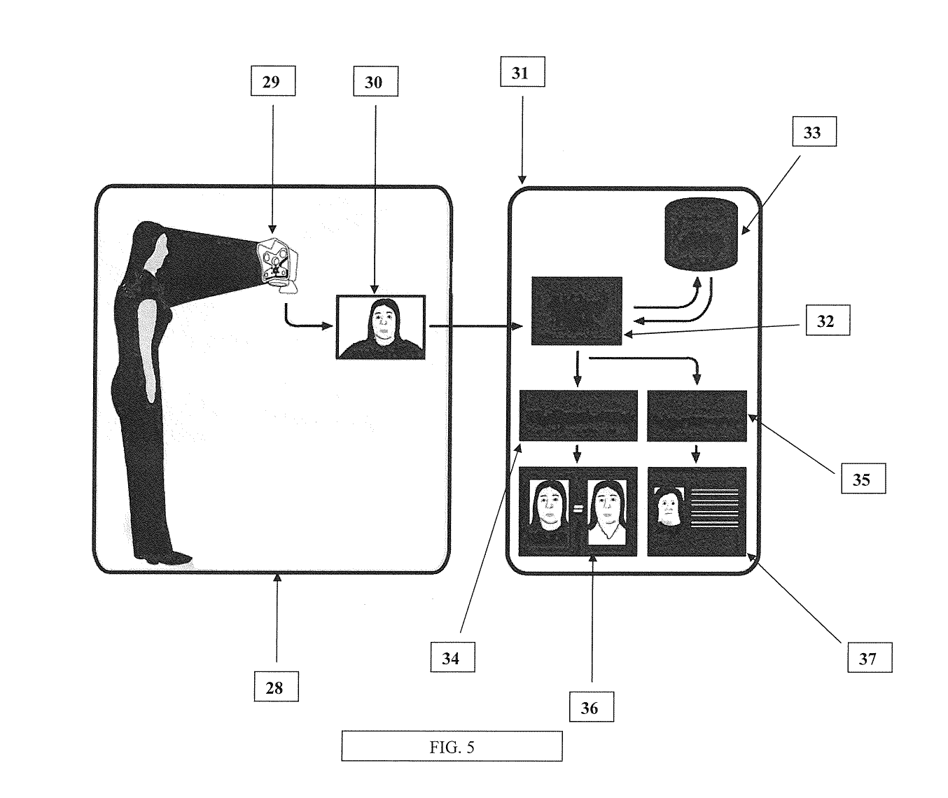

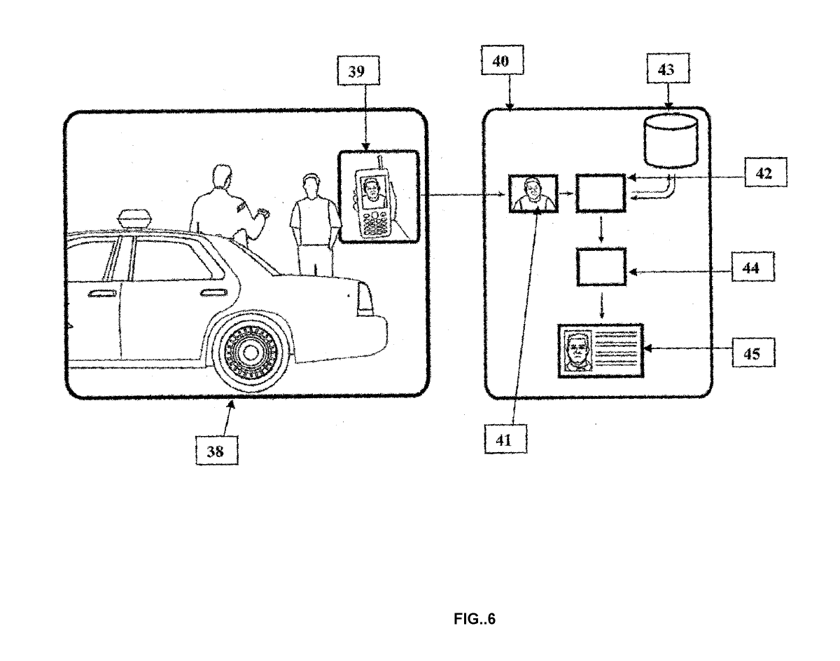

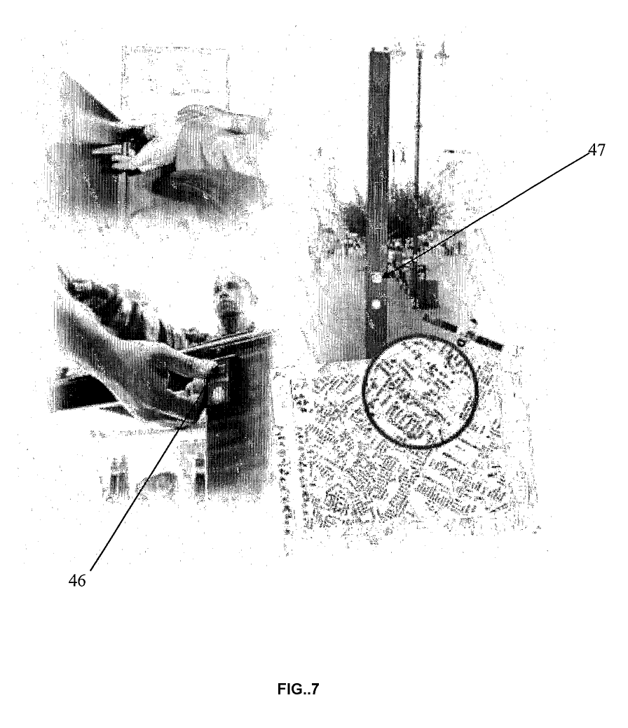

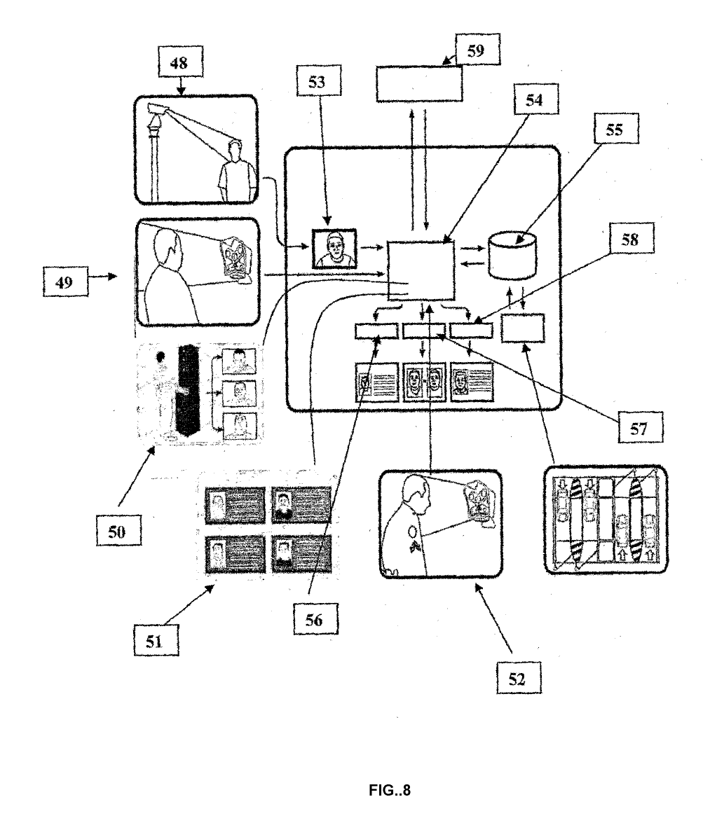

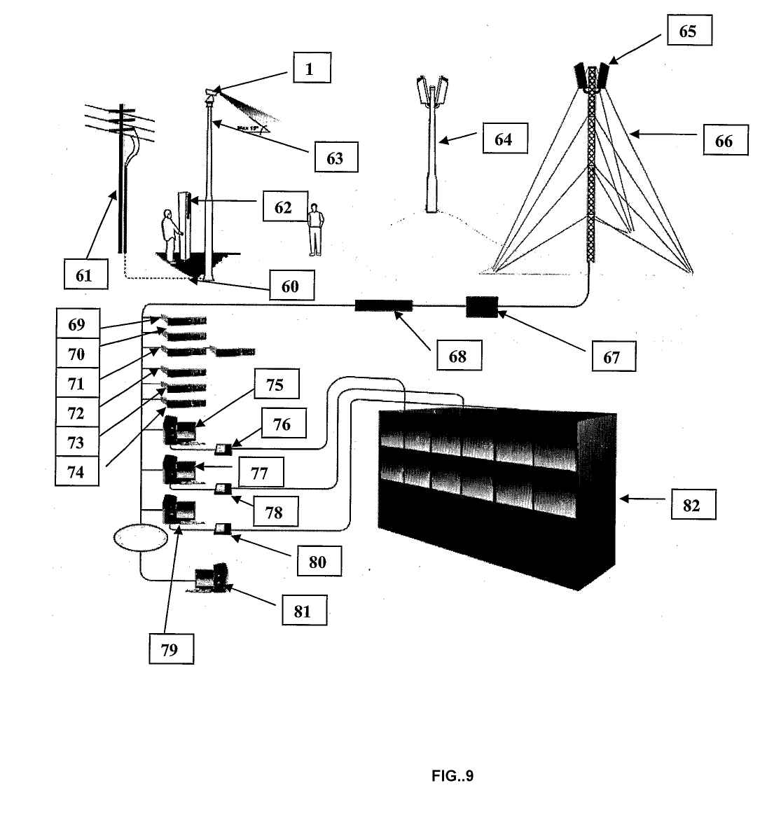

In connection with said figures, under (1) a camera with optical close-up may be observed, placed on a post or structure, said camera takes pictures, said picture is sent to the command center (2) by means of a data link transmitting the photograph (3), in real time, said photograph is sent to a global module of facial recognition process (4) which transmits it in turn to a security filter (5) for its analysis and once information is verified it sends it back to the module (49 and it goes from there to the individuals identification module (6) and it edits the photograph or card with all data (7); FIG. 2 shows the arrangement of a series of microphones (8) coupled over a structure and an electronic board (9), said arrangements enable recognition of sound signatures such as gunshots in different noise intensities; FIG. 3 represents the facial recognition system (10) incorporated by a photograph or digital video camera in the urban centers (11), which has a verification module by means of facial recognition (12) which is linked to the command center (13) which has a facial recognition module (14) which transmits the photograph to a security filter (15) which sends it back to module (14) and it sends it to the verification module (16) which once the information is verified it sends it to the identification module to reproduce the card (18) corresponding to all necessary data; FIG. 4 represents the collection system of public security personnel comprising a personnel module (19) which has a camera (20) taking pictures of the personnel and it edits a photograph (21) which is linked to the control module (22) which sends the photograph to the security filter (23) and it sends it to the control module (22) that transmits it to the coding module (24) and from there to the identification module (25) and from there to the photograph registry (27) and in addition, to the verification module (26) which is linked to the coding module (24); regarding FIG. 5 a data collection system of innocent individuals may be observed including an identification module (28) including a camera (29) which in addition verifies the photograph (39) and it sends it through the network to the command center which is verified against a list of individuals with criminal background or individuals sought for any reason (31) which as a reception module (32) which sends the photograph to a filter module (33), this goes again to module (32) and from there it is transmitted to the verification module (34) and this in turn, is transmitted to the identification module (35), once the photograph is verified (36), it is edited and it is incorporated as the registry (37); in connection with FIG. 6, it represents the remote data transmission from data mobile terminals and satellite location, comprised by a remote database of facial recognition (38) that by means of a camera integrated in the mobile data unit (39) and through a cellular data network it transmits it through wireless means to the command center (40) once the photograph is received (41) it is transmitted to the data collection module (42) and from there to the security filter (43) which sends it back to module (42) and from there to the individuals identification module (44) the individual is compared (45) against all the individual's data; FIG. 7 represents the city alarm system (46) which has cameras and videos to identify the individuals and it also has emergency alarms (47) which automatically receives the signal upon emergency button is pressed in less than 10 seconds to respond upon being pressed; FIG. 8 represents a general layout of the command center comprising a urban camera (48), public security module (49; identification module in arrest centers (50), driving licenses coding (51), personnel records (52), photograph (53), all these modules are linked to the data reception module (54) which sends it to the security module (55), and once said data is coded it sends it to the module (54) and module (54) sends it to modules (56), (57) and (58) which are identification, verification and registry modules, there is also a verification of vehicles point by means of the cellular data network and location by satellite positioning and the data reception module (54) which is used for consultation (59); regarding FIG. 9 a general layout of video-surveillance installation to the command center may be observed which includes an electric power post (61) and an electric connection (60), a post to place the city alarm (62), a post on which the camera with optical close-up is placed (1) with a series of sound transmitters (63), a repeater (64), a receptor (65) with a series of reception antennas (66), a video coder (67) and data network equipment (68) all of these elements are connected to a database consultation server (69), likewise, an emergency and city alarms server comprising satellite location (70), a facial recognition CPU (71) and another taping, matrix control and customers control server (72) and other series of high capacity storage servers (74) and from there to a screen for observers that have (75) a control (76) and from there to other series of observers displays (77), (79) with their controls (78), (80) and from there to a general visualization display (81) all modules are parallel connected to the mainframe (82) which includes a specific number of visualization displays.

### General Development of the Different Modules of the System

1) Urban Surveillance and Facial Recognition Cameras.

Urban surveillance cameras system enables the observation in a variable distance perimeter, according to the type of installed camera, which enables to have the visual control of all the area where the surveillance camera is installed. This analysis allows the simultaneous work of observation and facial recognition of individuals as from the coding during arrests, driving licenses or individuals sought in the entities. The system is connected in the entity by means of data links located where there are urban surveillance cameras. Information obtained is centralized and analyzed on real-time providing an immediate response to personnel locally watching and personnel located in the Command Center. This video is locally used in each entity for surveillance purposes and for facial recognition in real-time from the command center.

2) Gunshots Detector

It enables the recognition of sounds signatures, such as gunshots in different noise intensities (traffic or environment noise) without affecting its performance. It determines the direction and location of the point where the gunshot was made. It works together with a PTZ controller. This information is delivered to the observer as an alarm. This technology is based on neural networks which enable recognition of specific sounds, identification of sound and provision of the direction towards the detected sound even under great intensity noise conditions on the back. The detection of sound unit recognizes a gunshot of different caliber at different distance according to the caliber of the detonated firearm under normal conditions and the detection of a gunshot is possible up to 400 meters under low noise conditions. Upon detecting the gunshot, the system sends a visible and audible alarm to the command center. It immediately positions the mobile camera to where the gunshot was made. All this information is received by the command center and it is stored 24 hours a day. Gunshots detectors are installed on strategic points to reinforce in this way the most important areas in the different entities.

3) Facial Recognition System

This system enables de arrest of suspects from the terminals enabled with a photograph or digital video camera on the urban surveillance points and arrest centers. Blank fields are the following: offenders registration, name, physical characteristics, marks, height, weight, hair color, sex, eyes color, race, skin color, alias, full address of individual, age, arrest date, committed crime, ID of a suspect or offender using the facial biometric recognition, arrest place, accusation number, accusation agency, individual making the accusation. In addition it collects the individual's image for processing the facial characteristics; it also collects the images of special characteristics, such as tattoos, injuries, scars, deformities, amputations, etc. Accusing personnel, transfer personnel, detention place, type of crime, affiliation, accessories, alerts (psychology characteristics of dangerous behavior). Photographs are compared on real-time against a database of sought individuals and it may be implemented with connection to other entities by means of the corresponding agreements.

4) Data Collection System of Public Security Personnel.

This system enables the data collection of personnel data for its identification and control in the facial recognition module. It enables the verification of personnel to be hired in the registries of individuals with background registered in the database by means of facial recognition. Federal Tax Payers, military service card, address, cellular phone, e-mail, job telephone number, address, district, class index which he/she would be hired, former position, beginning date, work type, type, shift, credential, grade, blood type, type of firearm to grant, physical location, department, issuance date, arrival date, hiring date, initial date, prior service, promotion, language skills. It enables verification in case investigation is required based on the photographs or video sources, public security staff is verified in the database of sought individuals or with criminal background.

5) Data Collection System of Innocent Individuals

This system enables the data collection of innocent people to be sought in public security databases in any local, state or national entity, in institutions where the system has been installed, such as hospitals, missing persons databases, etc. Blank fields are the following: name, physical characteristics, marks, height, weight, hair color, sex, eyes color, race, skin color, nickname, full address of individual, age, data collection date, address of the place where the individual was last seen, person filing the denounce. It creates reports for the creation of pamphlets of missing or sought people. Photograph is taken and stored for its subsequent analysis when the facial recognition license is installed. Innocent individuals system is incorporated along with the sole identification of persons; one person is coded upon obtaining his/her sole identification license.

6) Remote Data Transmission from Data Mobile Terminals and Satellite Location.

Remote data transmission system from mobile terminals via a wireless data network. It enables the transmission to the command center of photographs for their analysis from data mobile units. The result is the former file of the arrested person. The system takes a picture from the mobile unit by means of a 2D scanner, camera, scanner, etc. Said photograph is zipped for its wireless transmission to the command center. The location system enables the verification of individuals and vehicles on real-time. This system may be applied to police officers and to vehicles. The fixed satellite localization system in vehicles enables the transmission of localization by police vehicles or private vehicles as a community service. This service is of great help for the search of stolen vehicles or kidnapped persons.

7) City Alarm System

System enabling the reception and transmission in real time from Emergency Urban Alarms and individual emergency alarms. The system is activated in a period not longer than 10 seconds from the portable equipment up to less than a second in urban alarms. Emergency is immediately visualized by the installed command center. This system is installed in front of each camera, likewise, it is available for all population, commerce, Banks, dwelling and it is distributed among the schools by means of a portable City Alarm and by means of the City Alarm with satellite location.

The system allows the video transmission in real time from that commerce or bank that optionally has a video camera. Video is transmitted in real time upon receiving the emergency notice.

8) System Detection of Violations and Vehicle Control

Urban Surveillance Cameras System enables the observation in the perimeter of the camera which enables to have the visual control of all the area where the surveillance camera is installed. This camera system enables the recognition of driving plates for the detection of the vehicles under traffic violation. The system is connected in the entity by means of localized data links where there are urban surveillance cameras. Information obtained is centralized, analyzed and sent to a violations registry system to apply the corresponding fine in real time providing an immediate response to the personnel watching the entity and the personnel located in the Command Center. This video is locally used in each entity for detection of traffic violations and for registry and collection of fines resulting from the incurred traffic violations. The Command Center sends an automatic report to the system of data and driving plates which may not be modified or changed by any operator to optimize the fines collection for traffic violations and it will also fight corruption and bad image of the police before the citizens.

The system issues an automatic fine and it is sent by mail to infringer for payment in Banks, commerce or in reception cashiers. Likewise, a notice to the database is issued by means of which an individual sanctioned by other method (parkimeter, verification centers, fines by commercial police) is detected for collection in each method.

9) Service Payments System

This system works by means of intelligent electronic units for making different payments on rapid and simple basis to be used along with other electronic fine systems, different payments, bonus management, among others.

It has four main components: Parkimeters in the vehicle, prepaid system, control system, units to verify a parkimeter.

Parkimeter in the vehicles. It is a system based on electronic equipment, no contact operation based on infrared emission, this security has advanced security characteristics, easy to use, personal system with intelligent card in the vehicle to: enable additional benefits for the customer in defined areas, enable higher security levels and differential rates associating a specific vehicle to each card.

Prepaid system, self-service system easy to use, system based on a PC or with staff, it uses current infrastructure, permanent interaction with final users.

Control system, it controls and monitors all sub-systems, it automatically collects parkimeter collections, it creates periodic reports for the government, accessible interfaces for government personnel.

Collection system, it enables automatic inspection of cards, it tapes the amount of verified vehicles, manual unit, easy to use.

This system also creates the necessary structure for electronic fines since control elements are in the field they may issue the fines to all automobiles violating the traffic, upon being detected, for instance, from the command center where the current situation of the vehicle is verified on remote basis.

10) Identification System and Payment Means.

This system will enable collection of highly important information for an entity by means of issuance of a unique II) as an ID card, which it turn it is used as identification means and registry for any formality or public service and for payment as debit card which shall be a very important information source for central databases due to the great deal of generated information which will be daily concentrated and that in turn it may analyzed and compared against all systems currently being installed for their different purposes both public security and electronic government, in general, by means of matching of these databases.

This ID system will be used for support programs by means of the use of sole identification as a prepaid card which may be issued by an entity for different types of use and discounts that may be obtained with agreements with self-service stores, supermarkets, etc.

This intelligent card enables the control of public services payment by means of an advanced electronic system of funds administration which enables the citizen and the municipal, state or federal government a simple and efficient administration for the payments of parkimeters, municipal services payment, transportation payment, fines payment, among others.

11) Command Center

The command center is the reception point of all the operations, it is here where the information obtained from the different previously mentioned systems is received and managed and where this information is consolidated and analyzed. Specifically, the command center is controlled from a sole visualization interface which may be of different types such as frontal projection or rear projection.

Therefore, in this way we may see how the command center works as a brain through systematization of operation of each one of the last for items and only as system brain of each one of these functions without distracting at all its main surveillance and prevention function.

1. Remote and digital data transmittal system and satellite location from mobile and fixed terminals with urban surveillance cameras for facial recognition, shots detector, loading of public security staff and lost or kidnapped individuals and citizenship alarm, stolen vehicles, application of electronic fines and collection thereof through an identification personal system by means of a multifunctional card and collection of services, all elements are connected to a command center comprising the combination of a series of urban surveillance cameras and facial recognition, shots detector, loading of security personnel system, loading of innocent individuals system, remote data transmittal from mobile data terminals and satellite location, a citizenship alarm system, a command center, characterized because the installation system of video-surveillance is connected to the general control center and it includes a camera (1), placed on the upper part of the post forming a 15 degrees angle of the from the top to the bottom part of said post, with optical close up placed over a post or structure to take a frontal picture, said picture is sent tot he command center (2) by means of a data link providing the picture (3), on real time, said picture passes to a global module and processing of facial recognition (4), which transmits it to a security filter (5) for its analysis and once information is ensured, it sends it back to the global module and facial recognition process (4), and from here it is sent to the individuals identification module (6), and it edits the picture or credential with all data (7), in addition of presenting an arrangement of a series of microphones (8), coupled on a structure and an electronic switchboard (9), said arrangements enable the recognition of signatures produced by emission of such as shots in different noise intensities in the surroundings of the cameras and said signatures are sent by sound transmitters to a reception module for their analysis; likewise, the facial recognition system (10) is comprised by a photographic camera or digital video in the urban centers (11), which have a facial verification module (12), which is linked with the command center (13), which it also has a facial and global recognition module (14), which passes the picture to a security filter (15), which sends it back to the facial and global recognition module (14), and it sends it from there to the verification module (16) which once the information is verified, it sends it to the identification module to reproduce the credential (18), corresponding to all necessary data.

2. Remote and digital data transmittal system and satellite location from mobile and fixed terminals with urban surveillance cameras for facial recognition, shots detector, loading of public security staff and lost or kidnapped individuals and citizenship alarm, stolen vehicles, application of electronic fines and collection thereof through an identification personal system by means of a multifunctional card and collection of services, all elements are connected to a command center according to claim 1 characterized in addition, the system has a loading system of public security personnel which is comprised by a personnel module (19), which has a camera (20) with a slope at 15 degrees regarding the bottom part of the structure and that takes a picture to the staff and it edits the picture (21), which links with the command center (22), that sends the picture to the security filter (23), and said security filter sends it back to the command center (22), which passes to the codification module (24) and from there to the identification module (25), and from there to the pictures registry (27), and also to the verification module (26), which is linked to the codification module thus editing the picture with all necessary data of the individual (24).

3. Remote and digital data transmittal system and satellite location from mobile and fixed terminals with urban surveillance cameras for facial recognition, shots detector, loading of public security staff and lost or kidnapped individuals and citizenship alarm, stolen vehicles, application of electronic fines and collection thereof through an identification personal system by means of a multifunctional card and collection of services, all elements are connected to a command center according to claim 1 characterized in addition because the innocent individuals loading system which includes an identification module (28), which includes a photographic camera (29), which in addition it verifies the picture (30), and it sends said picture through the network to the command center (31) which is verified against a list of individuals with criminal background or searched for any reason, likewise, it has a reception module (32), which sends the picture to a filtration module (33), said filtration module sends it in turn to module (32) and from there to the verification module (34) and said verification module sends it in turn to the identification module (35), once the picture (36) is verified, it is edited and it creates credential (37), with all the individuals data.

4. Remote and digital data transmittal system and satellite location from mobile and fixed terminals with urban surveillance cameras for facial recognition, shots detector, loading of public security staff and lost or kidnapped individuals and citizenship alarm, stolen vehicles, application of electronic fines and collection thereof through an identification personal system by means of a multifunctional card and collection of services, all elements are connected to a command center according to claim 1 characterized in addition because the remote data transmittal system from mobile terminals and satellite location is comprised by a remote facial recognition database (38), that by means of a wireless camera in a data mobile unit (39), or cellular phone sends it by means of wireless means to the command center (40), and the picture is received (41), it is passed from here to the registry module (42) and from here to the security filter (43), which sends it back to module (42), and from here to the individuals identification module (44), and picture is printed (45), with all individual's data.

5. Remote and digital data transmittal system and satellite location from mobile and fixed terminals with urban surveillance cameras for facial recognition, shots detector, loading of public security staff and lost or kidnapped individuals and citizenship alarm, stolen vehicles, application of electronic fines and collection thereof through an identification personal system by means of a multifunctional card and collection of services, all elements are connected to a command center according to claim 1 characterized in addition because the citizenship alarm system (46), which has cameras and videos to identify the individuals and that it also has emergency alarms (47), which automatically get the signal upon pressing a button in case of emergency and in less than 10 seconds, it detects the sound and immediately acts, in addition the command center comprises the urban camera (48) with a slope of 15 degrees from the bottom part of the post to the bottom thereof, likewise, it has a public security model (49), and an identification module in the CERESOS (Social Readaptation Centers CERESOS for its initials in Spanish) (50), a license encoder (51) and a personnel registry (52), where the picture (53) and all these modules are connected to the data reception module (54), which sends them to the security module (55), and once ensured it sends them back to module (54), and module (54), sends them to modules (56), (57), and (58), which are individuals and/or vehicles identification, verification and registration modules, in addition there is the satellite vehicles verification and the data reception module (54), which is used for consultation (59).

6. Remote and digital data transmittal system and satellite location from mobile and fixed terminals with urban surveillance cameras for facial recognition, shots detector, loading of public security staff and lost or kidnapped individuals and citizenship alarm, stolen vehicles, application of electronic fines and collection thereof through an identification personal system by means of a multifunctional card and collection of services, all elements are connected to a command center according to claim 1 characterized in addition because the video surveillance system to the command center which includes an electric power post (61), and one electric power connection (60), a post to place the citizenship alarm (62), a post on which the camera with optical close up is placed (1), with a series of sound transmitters (63), a repeater (64), a receptor (65), with a series of reception antennas (66), and some injectors (67), with a series of switches (68), of various gigabits, all and each one of these elements are connected to a database consultation server (69), to another server and a citizenship alarm (70), to a facial recognition center (71), and to other recording, registration and customers records server (72) and to other series of massive hosting servers (74), and from here to other series of an observing monitor (75), with control (76), and from here to other series of observing monitors (77), (79), with their controls (78), (80), and from here to the general visualization screen (81), all modules are connected in parallel and they are connected to the main console (82), which includes several visualization screens for the detection of lost individuals and vehicles.

7. Remote and digital data transmittal system and satellite location from mobile and fixed terminals with urban surveillance cameras for facial recognition, shots detector, loading of public security staff and lost or kidnapped individuals and citizenship alarm, stolen vehicles, application of electronic fines and collection thereof through an identification personal system by means of a multifunctional card and collection of services, all elements are connected to a command center according to claim 1 characterized in addition because the system is connected to an entity by means of data links located where there are urban surveillance cameras (1) with a slope of 15 degrees enabling to have a visual control of all the area where said camera is installed, this cameras system enables the recognition of vehicle plates to detect the vehicles committing infringements and said system is connected by means of data links located where there are urban surveillance cameras and said resulting information is centralized, analyzed and sent to an infringement registration system to apply the corresponding fine on real time, giving an immediate response to the personnel watching the entity and to the personnel located in the Command Center. This video is locally used in each entity for detection of traffic infringements purposes and for registration and collection of fines resulting from incurred traffic infringements, through the command center the automatic report for vehicle data and plates is prepared to load into the system, the automatic report or infringement will be attached thereto and it may not be modified or changed by any operator.

8. Remote and digital data transmittal system and satellite location from mobile and fixed terminals with urban surveillance cameras for facial recognition, shots detector, loading of public security staff and lost or kidnapped individuals and citizenship alarm, stolen vehicles, application of electronic fines and collection thereof through an identification personal system by means of a multifunctional card and collection of services, all elements are connected to a command center according to clam 1 characterized because it has the service payment system which works by means of intelligent electronic units for the rapid and easy payment of different payments to be used along with other electronic fine, different payments, parking payment systems, among others.

9. Remote and digital data transmittal system and satellite location from mobile and fixed terminals with urban surveillance cameras for facial recognition, shots detector, loading of public security staff and lost or kidnapped individuals and citizenship alarm, stolen vehicles, application of electronic fines and collection thereof through an identification personal system by means of a multifunctional card and collection of services, all elements are connected to a command center according to claim 1 characterized in addition because it has a sole identification system by means of an identity card that it will serve in turn either for identification means or for registration for any proceeding or public service and for their payment and debit card which will be a source generating information to central databases which is very important due to the great deal of information which will be generated and centralized on daily bases and that it may be analyzed and compared in turn by means of cross-analysis against all the systems currently being installed in their different uses both for public security and for electronic Government in general.
